(19) United States
(12) Patent Application Publication
(10) Pub. No.: US 2026/0086990 A1
(43) Pub. Date: Mar. 26, 2026

(54) METHOD AND APPARATUS FOR GENERATING DATA

(71) Applicant: Electronics and Telecommunications Research Institute, Daejeon (KR)

(72) Inventor: Suwook HA, Daejeon (KR)

(73) Assignee: Electronics and Telecommunications Research Institute, Daejeon (KR)

(21) Appl. No.: 19/295,869

(22) Filed: Aug. 11, 2025

(30) Foreign Application Priority Data
Sep. 23, 2024 (KR) 10-2024-0128405

(51) Int. Cl. G06F 16/215; G06F 16/2455

(52) U.S. Cl. CPC G06F 16/215; G06F 16/2456

(57) ABSTRACT

A method and apparatus for generating and merging synthetic data to provide data that satisfies desired data quality are provided. The method includes receiving original data and a desired data quality level from a user, determining an original data quality level of the original data, determining a data generation model by additionally training an initial model, which is pre-trained to receive an input data quality level and generate output data of the input data quality level, using the original data and the original data quality level, generating synthetic data by executing the data generation model using the desired data quality level, generating merged data by combining the original data with the synthetic data, and providing the merged data to the user.

### CROSS-REFERENCE TO RELATED APPLICATION

This application claims the benefit of Korean Patent Application No. 10-2024-0128405, filed on September 23, 2024, in the Korean Intellectual Property Office, the entire disclosure of which is incorporated herein by reference for all purposes.

### BACKGROUND

### 1. Field of the Invention

One or more embodiments relate to a method and apparatus for generating data.

### 2. Description of the Related Art

Synthetic data refers to data that is artificially generated using computer algorithms based on real data. Synthetic data may replace or supplement real data. Synthetic data is data that may avoid ethical and legal issues that may arise when sharing real data, and may be used in various fields. For example, synthetic data may be used in fields such as autonomous driving, medicine, and finance. Synthetic data may be generated using a deep learning model such as a generative adversarial network (GAN). Synthetic data may be used to train machine learning models.

### SUMMARY

Machine learning technology is being used in various fields. In some fields, it may be difficult to prepare data that satisfies data quality required for machine learning. For example, a MyData environment, which focuses on individuals to directly manage and utilize their own data, collects data from various sources, and thus, it may be difficult to obtain a uniform amount of data when collecting data. When a machine learning model is trained with data of poor quality, there may be a negative impact on data analysis and performance of the machine learning model.

According to an aspect, there is provided a data generation method including receiving original data and a desired data quality level from a user, determining an original data quality level of the original data, determining a data generation model by additionally training an initial model, which is pre-trained to receive an input data quality level as input and generate output data of the input data quality level, using the original data and the original data quality level, generating synthetic data by executing the data generation model using the desired data quality level, generating merged data by combining the original data with the synthetic data, and providing the merged data to the user.

According to another aspect, there is provided a data generation apparatus including one or more processors and a memory including instructions executable by the one or more processors, wherein the instructions, when executed by the one or more processors, cause the data generation apparatus to receive original data and a desired data quality level from a user, determine an original data quality level of the original data, determine a data generation model by additionally training an initial model, which is pre-trained to receive an input data quality level as input and generate output data of the input data quality level, using the original data and the original data quality level, generate synthetic data by executing the data generation model using the desired data quality level, generate merged data by combining the original data with the synthetic data, and provide the merged data to the user.

According to another aspect, there is provided a data generation apparatus including a user interface configured to receive original data and a desired data quality level from a user and provide the user with merged data based on the original data and the desired data quality level, a quality evaluation module configured to determine an original data quality level of the original data, a model processing module configured to determine a data generation model by additionally training an initial model, which is pre-trained to receive an input data quality level as input and generate output data of the input data quality level, using the original data and the original data quality level and generate synthetic data by executing the data generation model using the desired data quality level, and a merge module configured to generate the merged data by combining the original data with the synthetic data.

Additional aspects of embodiments will be set forth in part in the description which follows and, in part, will be apparent from the description, or may be learned by practice of the disclosure.

According to embodiments, data provided to a user may be data that satisfies required data quality. For example, the data may be data including uniform amounts.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram schematically illustrating an operation of a data generation apparatus for generating synthetic data and merged data based on original data received from a user, according to an embodiment;

FIG. 2 is a flowchart illustrating an example of an operation of providing a user with merged data that satisfies a desired data quality level by a data generation apparatus that has received original data and the desired data quality level, according to an embodiment;

FIG. 3 is a flowchart illustrating an example of an operation of generating synthetic data that satisfies a synthetic data quality target, according to an embodiment;

FIG. 4 is a flowchart illustrating an example of an operation of generating merged data that satisfies a desired data quality level, according to an embodiment;

FIG. 5 is a flowchart illustrating an example of an operation of generating merged data using a merge rule, according to an embodiment;

FIG. 6 is a flowchart illustrating an example of an operation of generating synthetic data until it is predicted that merged data satisfies a desired data quality level, according to an embodiment;

FIG. 7 is a diagram illustrating an example of a configuration of a data generation apparatus including a plurality of hardware modules, according to an embodiment;

FIG. 8 is a diagram illustrating an example of a data generation process within a data generation apparatus, according to an embodiment;

FIG. 9 is a flowchart illustrating a method of providing data that satisfies desired data quality, according to an embodiment; and

FIG. 10 is a block diagram illustrating a configuration of an electronic device for providing data that satisfies desired data quality, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being "connected", "coupled", or "joined" to another component, a third component may be "connected", "coupled", and "joined" between the first and second components, although the first component may be directly connected, coupled, or joined to the second component.

The singular forms "a", "an", and "the" are intended to include the plural forms as well, unless the context clearly indicates otherwise. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, the embodiments are described in detail with reference to the accompanying drawings. When describing the embodiments with reference to the accompanying drawings, like reference numerals refer to like components and a repeated description related thereto will be omitted.

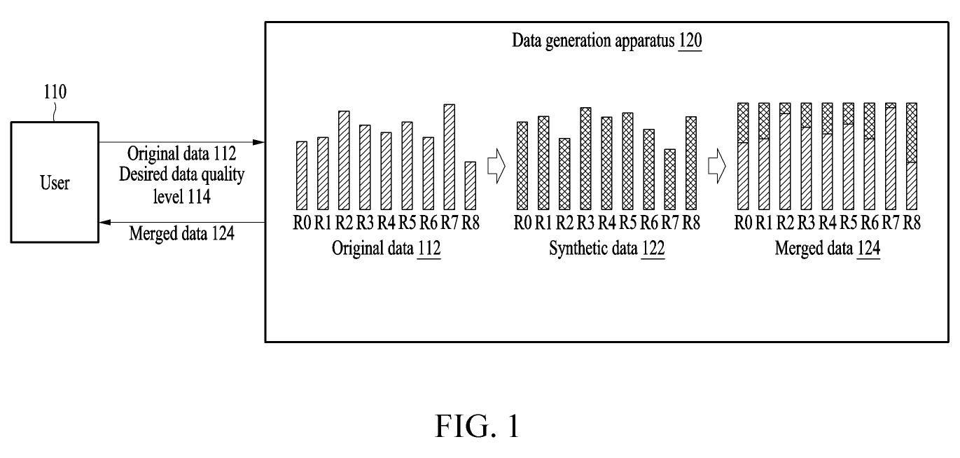

FIG. 1 is a diagram schematically illustrating an operation of a data generation apparatus for generating synthetic data and merged data based on original data received from a user, according to an embodiment. Referring to FIG. 1, a data generation apparatus 120 may receive original data 112 and a desired data quality level 114 from a user 110. The data generation apparatus 120 may generate synthetic data 122 and merged data 124. The data generation apparatus 120 may provide the merged data 124 to the user 110. Although FIG. 1 illustrates that the data generation apparatus 120 provides the merged data 124 to the user 110, it may also be possible that the data generation apparatus 120 provides the synthetic data 122 to the user 110. The user 110 may refer to a terminal used by a user to upload data to the data generation apparatus 120 or download data from the data generation apparatus 120.

The original data 112 may be data collected by the user 110. Each of R1 to R8 of the original data 112 may refer to a category of data. For example, each of R1 to R8 may represent an age range, with R0 representing under 10 years old and R1 representing teenagers. For example, each of R1 to R8 may represent recency of data, with R0 representing the latest data and R8 representing the oldest data. FIG. 1 shows an example with eight categories of data, but the number of categories of data is not limited to eight. The height corresponding to each of R1 to R8 may be the number of data samples belonging to the corresponding category. R1 to R8 of the synthetic data 122 and the merged data 124 may perform the same function as R1 to R8 of the original data 112.

The desired data quality level 114 may be the level of data quality of the merged data 124 desired by the user 110. The desired data quality level 114 may be the level of data quality of the synthetic data 122 desired by the user 110. The desired data quality level 114 may include one or more data quality evaluation criteria. The data quality evaluation criteria of the desired data quality level 114 may be criteria arbitrarily set by the user 110. The data quality evaluation criteria of the desired data quality level 114 may be predefined criteria. For example, data quality evaluation factors of the desired data quality level 114 may be accuracy, reliability, completeness, consistency, and validity among data quality characteristics defined in International Organization for Standardization/International Electrotechnical Commission (ISO/IEC) 25024.

The desired data quality level 114 may include one or more desired conditions corresponding to each of one or more data quality evaluation criteria. The desired condition of the desired data quality level 114 may refer to a target value of the corresponding data quality evaluation criterion. The desired condition of the desired data quality level 114 may be set as a range. The desired data quality level 114 may be set to a threshold. For example, the user 110 may set the data quality evaluation criteria of the desired data quality level 114 to the accuracy and the completeness of ISO/IEC 25024 and may set both desired conditions corresponding to the accuracy and the completeness to 0.5 or higher.

The data generation apparatus 120 may evaluate the data using one or more quality evaluation functions. Each of one or more data quality evaluation criteria of the desired data quality level 114 may have a corresponding quality evaluation function. The quality evaluation function may be set based on the data quality evaluation criteria. The quality evaluation function may be a function arbitrarily set by the user 110. For example, the quality evaluation function may be a function that divides the number of pieces of data satisfying the data quality evaluation criteria set by the user 110 by the total number of pieces of data. The quality evaluation function may be a predefined function. For example, the quality evaluation function may be a function defined in ISO/IEC 25024. FIG. 1 may be an example in which the data quality evaluation criterion of the desired data quality level 114 is set to uniformity, which refers to uniformity of data samples, the corresponding quality evaluation function is set to a standard deviation of the number of data samples for each category of data, and the desired condition is set to 0 or less.

Evaluating specific data with the desired data quality level 114 may refer to evaluating the specific data with one or more quality evaluation functions corresponding to one or more data quality evaluation criteria of the desired data quality level 114. Satisfying the desired data quality level 114 by specific data may refer to that, when the specific data is evaluated by one or more quality evaluation functions corresponding to one or more data quality evaluation criteria of the desired data quality level 114, all of the values satisfy one or more desired conditions of the desired data quality level 114. For example, the original data 112 may not satisfy the uniformity, which is the desired data quality level 114, since the number of pieces of data corresponding to R1 to R8 is different from each other, but the merged data 124 may satisfy the desired data quality level 114 since the number of pieces of data corresponding to R1 to R8 is the same.

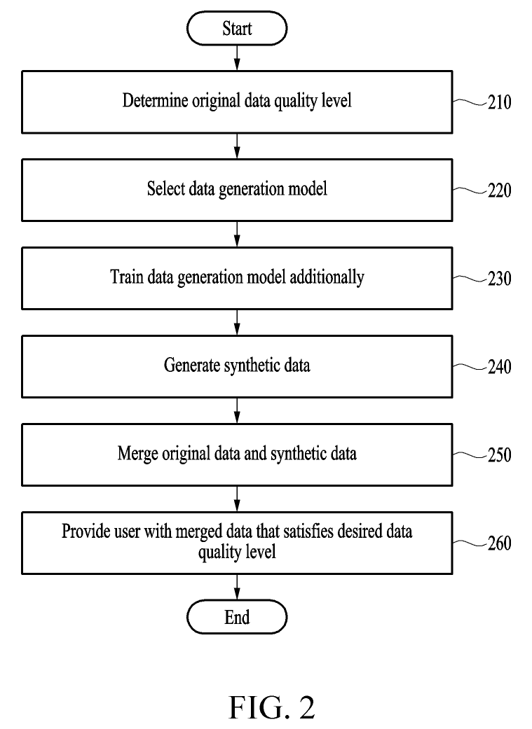

FIG. 2 is a flowchart illustrating an example of an operation of providing a user with merged data that satisfies a desired data quality level by a data generation apparatus that has received original data and the desired data quality level, according to an embodiment. Referring to FIG. 2, by a data generation model, synthetic data may be generated, original data may be merged with the synthetic data, and the merged data may be provided to a user.

In operation 210, an original data quality level of original data may be determined. The original data may be evaluated based on a desired data quality level. The original data quality level may be the level of data quality of the original data evaluated based on the desired data quality level. The original data quality level may be a result of evaluating the original data with one or more quality evaluation functions corresponding to one or more data quality evaluation criteria of the desired data quality level. The original data quality level may not satisfy the desired data quality level.

In operation 220, a data generation model may be selected. The data generation model may be a model for generating synthetic data. The data generation model may be selected from among one or more models stored in a data generation apparatus. For example, the one or more models stored in the data generation apparatus may include models such as a generative adversarial network (GAN), a diffusion model, a variational autoencoder (VAE), WaveNet, T5, etc.

The data generation model may be selected as a model suitable for generating the synthetic data that is similar to the original data. The data generation model may be selected as a model suitable for generating merged data that satisfies the desired data quality level. Although it is shown in FIG. 2 that operation 220 is performed after operation 210, operation 220 may be performed before operation 210 or in parallel with operation 210.

Each of the one or more models stored in the data generation apparatus may have an advantage in generating a particular type of data. For example, the GAN may have an advantage in generating data including images. For example, the WaveNet may have an advantage in generating voice data. The data generation model may be selected based on a data type of the original data. For example, when the original data is image data, the data generation apparatus may be selected as the GAN. For example, when the original data is voice data, the data generation apparatus may be selected as the WaveNet.

The data generation model may be selected from among one or more pre-trained initial models. The one or more initial models may have been pre-trained to, when a data quality level is input, generate data of the input data quality level. The one or more pre-trained initial models may be models obtained by training different models. The one or more pre-trained initial models may be models obtained by training a same model with different pieces of data. For example, the one or more pre-trained initial models may include a GAN that is pre-trained with medical X-ray image data, a GAN that is trained with medical radiography image data, and a GAN that is trained with financial image data.

In operation 230, the data generation model may be additionally trained. The data generation model additionally trained may be the data generation model selected in operation 220. The data generation model may be additionally trained using the original data. The data generation model additionally trained using the original data may generate the synthetic data that is similar to the original data. For example, when the original data is data from an X-ray image of the lungs, the data generation model may generate synthetic data that is similar to the data from the X-ray image of the lungs.

Preprocessing may be performed on the original data for additional training of the data generation model to be suitable for training of the data generation model. For example, data normalization, scaling, and outlier handling (e.g., via interquartile range (IQR) or standard score (Z-score)) may be performed on the original data.

The data generation model may be additionally trained using the original data quality level determined in operation 210. The data generation model may be additionally trained using all or a portion of the original data. The portion of the original data for additional training of the data generation model may be a portion of the original data having a data quality level that is higher or lower than the original data quality level. For example, a portion of the original data for additionally training the data generation model may have a higher data quality level than the original data quality level by excluding a portion of data that does not satisfy the data quality evaluation criteria. For example, the portion of the original data may be data that satisfies the desired data quality level. The data generation model trained using the portion of the original data that satisfies the desired data quality level may easily generate synthetic data that satisfies the desired data quality level.

Synthetic data may be generated in operation 240. The synthetic data may be generated by executing the data generation model additionally trained in operation 230. The synthetic data may be data that is similar to the original data. The synthetic data may be generated using the desired data quality level. The data generation model may receive the desired data quality level as input to generate the synthetic data. The data generation model may generate the synthetic data that satisfies the desired data quality level input to the data generation model. Even if the data generation model receives the desired data quality level as input, the synthetic data may not satisfy the desired data quality level. After the synthetic data is generated, it may be evaluated whether the synthetic data satisfies the desired data quality level.

In operation 250, the original data may be merged with the synthetic data. Merged data may be generated by merging the original data with the synthetic data. For merging, all or a portion of the original data may be combined with all or a portion of the synthetic data. To ensure reliability of the merged data, all of the original data may be used when combining the original data with the synthetic data. A merge rule may be used to combine the original data with the synthetic data. The desired data quality level may be used to combine all or a portion of the original data with all or a portion of the synthetic data. The merged data, in which the original data is merged with the synthetic data, may satisfy the desired data quality level. Even if the desired data quality level is used, the merged data may not satisfy the desired data quality level.

In operation 260, the data generation apparatus may provide the user with the merged data that satisfies the desired data quality level. To obtain the merged data that satisfies the desired data quality level, it may be evaluated whether the merged data satisfies the desired data quality level in operation 250.

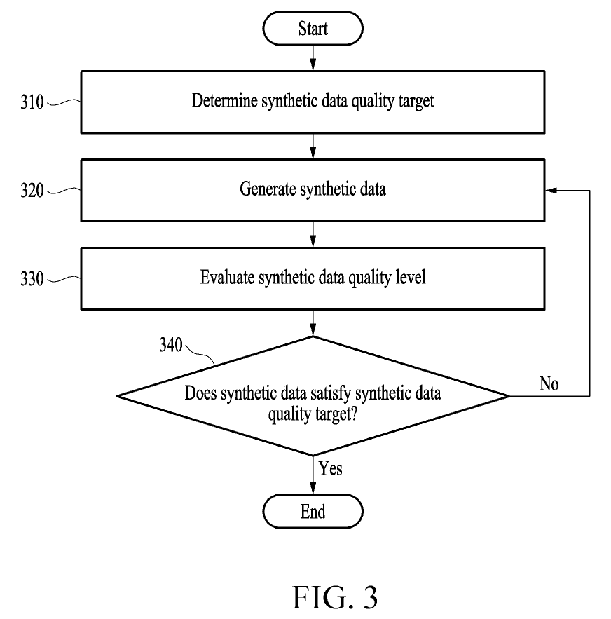

FIG. 3 is a flowchart illustrating an example of an operation of generating synthetic data that satisfies a synthetic data quality target, according to an embodiment. Referring to FIG. 3, the synthetic data may be repeatedly generated until the synthetic data satisfies the synthetic data quality target.

In operation 310, a synthetic data quality target may be determined. The synthetic data quality target may refer to a target value for the level of data quality of synthetic data. The synthetic data quality target may be determined to be the same as a desired data quality level. The synthetic data quality target may be determined differently from the desired data quality level. For example, the synthetic data quality target may have a higher desired condition than the desired data quality level so that merged data satisfies the desired data quality level that is higher than an original data quality level. For example, when a data quality evaluation criterion of the desired data quality level is the accuracy of ISO/IEC 25024, the desired condition corresponding to the accuracy is 0.5, and original data quality is determined to be 0.4, the synthetic data quality target may be determined as 0.6.

Operation 310 may be performed after operation 230 of FIG. 2. Operation 310 may be performed before operation 230 of FIG. 2. The synthetic data quality target may be used to additionally train a data generation model in operation 230 of FIG. 2. The data generation model may be additionally trained using a portion of original data that satisfies the synthetic data quality target. The data generation model trained using the portion of the original data that satisfies the desired data quality level may easily generate synthetic data that satisfies the desired data quality level.

In operation 320, synthetic data may be generated. Operation 320 may correspond to operation 240 of FIG. 2. The synthetic data may be generated using the synthetic data quality target. The data generation model may receive the synthetic data quality target as input to generate the synthetic data. The data generation model may generate the synthetic data that satisfies the synthetic data quality target input to the data generation model.

In operation 330, a synthetic data quality level may be evaluated. The synthetic data quality level may refer to the level of data quality of the synthetic data. It may be evaluated whether the synthetic data quality level satisfies the synthetic data quality target. When the synthetic data quality target and the desired data quality level are the same, it may be evaluated whether the synthetic data satisfies the desired data quality level.

In operation 340, when the synthetic data does not satisfy the synthetic data quality target, the process may return to operation 320. When the synthetic data does not satisfy the synthetic data quality target, the data generation model may be re-executed. When the synthetic data does not satisfy the synthetic data quality target, new synthetic data may be generated. When the synthetic data satisfies the synthetic data quality target, the synthetic data that satisfies the synthetic data quality target may be obtained. The synthetic data that satisfies the synthetic data quality target may be used to generate merged data. For example, the synthetic data that satisfies the synthetic data quality target may be provided in operation 250 of FIG. 2.

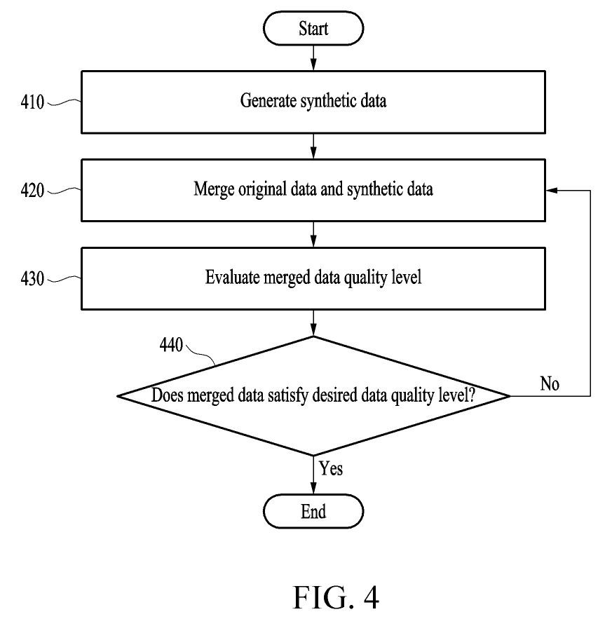

FIG. 4 is a flowchart illustrating an example of an operation of generating merged data that satisfies a desired data quality level, according to an embodiment. Referring to FIG. 4, the merged data may be generated repeatedly until the merged data satisfies the desired data quality level.

Synthetic data may be generated in operation 410. Operation 410 may correspond to operation 240 of FIG. 2 or operation 320 of FIG. 3. The synthetic data may satisfy a synthetic data quality target or a desired data quality level. After the synthetic data is generated, it may be evaluated whether the generated synthetic data satisfies the synthetic data quality target or the desired data quality level. When the synthetic data does not satisfy the synthetic data quality target or the desired data quality level, new synthetic data may be generated.

In operation 420, original data may be merged with the synthetic data. Operation 420 may correspond to operation 250 of FIG. 2. Merged data may be generated by merging the original data with the synthetic data. For merging, all or a portion of the original data may be combined with all or a portion of the synthetic data. When the new synthetic data is generated in operation 410, the merged data may be generated by merging the original data with the new synthetic data.

In operation 430, a merged data quality level may be evaluated. The merged data quality level may refer to the level of data quality of the merged data. It may be evaluated whether the merged data quality level satisfies the desired data quality level.

In operation 440, when the merged data does not satisfy the desired data quality level, the process may return to operation 420. When the merged data does not satisfy the desired data quality level, the original data may be recombined with the synthetic data. When the merged data does not satisfy the desired data quality level, new merged data may be generated.

Although FIG. 4 shows that the process returns to operation 420 when the merged data does not satisfy the desired data quality level, it may also be possible to return to operation 410. When the merged data does not satisfy the desired data quality level, new synthetic data may be generated. When the merged data does not satisfy the desired data quality level, the original data may be merged with the new synthetic data. When the merged data does not satisfy the desired data quality level, the new merged data may be generated by combining all or a portion of the original data with all or a portion of the new synthetic data.

When the merged data satisfies the desired data quality level, the merged data that satisfies the desired data quality level may be obtained. The merged data that satisfies the desired data quality level may be provided to a user. For example, the merged data that satisfies the desired data quality level may be provided to the user in operation 260 of FIG. 2.

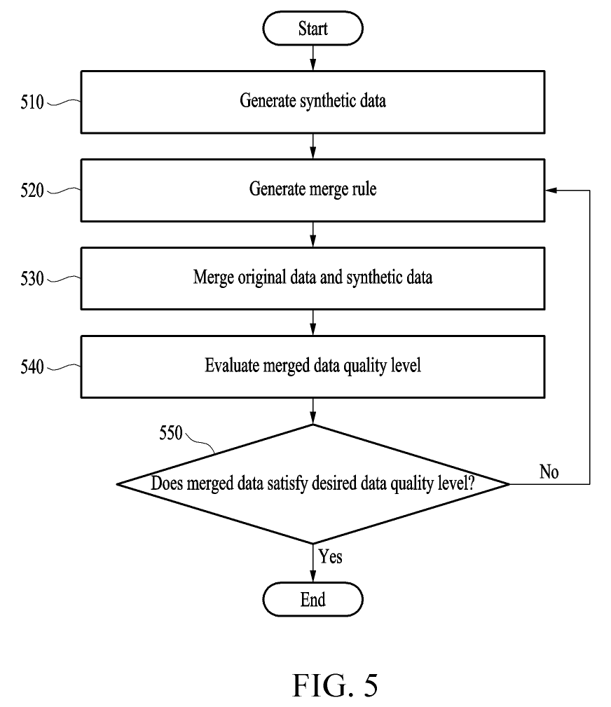

FIG. 5 is a flowchart illustrating an example of an operation of generating merged data using a merge rule, according to an embodiment. Referring to FIG. 5, the merge rule and the merged data may be repeatedly generated until the merged data satisfies a desired data quality level.

In operation 510, synthetic data may be generated. Operation 510 may correspond to operation 240 of FIG. 2, operation 320 of FIG. 3, or operation 410 of FIG. 4. The synthetic data may satisfy a synthetic data quality target or a desired data quality level. After the synthetic data is generated, it may be evaluated whether the generated synthetic data satisfies the synthetic data quality target or the desired data quality level. When the synthetic data does not satisfy the synthetic data quality target or the desired data quality level, new synthetic data may be generated.

A merge rule may be generated in operation 520. The merge rule may refer to a rule for merging original data with the synthetic data. The merge rule may be a rule for selecting a portion of the generated synthetic data to be merged. The merge rule may be generated based on the desired data quality level. When there is no merge rule, a portion of the synthetic data may be randomly selected when all or a portion of the original data and a portion of the synthetic data are merged. When the merge rule is set appropriately, the time required to evaluate whether merged data satisfies the desired data quality level may be saved.

The merge rule may be determined based on an original data quality level and the desired data quality level. For example, when the desired data quality level includes a plurality of data quality evaluation criteria, a target value of data quality of the synthetic data may be determined based on desired conditions corresponding to the plurality of data quality evaluation criteria and original data quality, and the merge rule for achieving the target value of the data quality of the synthetic data by selecting a portion of the synthetic data may be generated.

In operation 530, the original data may be merged with the synthetic data. Operation 530 may correspond to operation 250 of FIG. 2 or operation 420 of FIG. 4. The original data and the synthetic data may be generated based on the merge rule. For merging, all or a portion of the original data may be combined with all or a portion of the synthetic data. When new synthetic data is generated in operation 510, the merged data may be generated by merging the original data with the new synthetic data.

In operation 540, a merged data quality level may be evaluated. Operation 540 may correspond to operation 430 of FIG. 4. The merged data quality level may refer to the level of data quality of the merged data. It may be evaluated whether the merged data quality level satisfies the desired data quality level.

In operation 550, when the merged data does not satisfy the desired data quality level, the process may return to operation 520. When the merged data does not satisfy the desired data quality level, a new merge rule may be generated. When the merged data does not satisfy the desired data quality level, the original data may be recombined with the synthetic data based on the new merge rule. Although FIG. 5 shows that the process returns to operation 520 when the merged data does not satisfy the desired data quality level, it may also be possible to return to operation 530. When the merged data does not satisfy the desired data quality level, the original data may be recombined with the synthetic data. When the merged data does not satisfy the desired data quality level, new merged data may be generated.

Although FIG. 5 shows that the process returns to operation 520 when the merged data does not satisfy the desired data quality level, it may also be possible to return to operation 510. When the merged data does not satisfy the desired data quality level, new synthetic data may be generated. When the merged data does not satisfy the desired data quality level, the original data may be merged with the new synthetic data based on the new merge rule. When the merged data does not satisfy the desired data quality level, the new merged data may be generated by combining all or a portion of the original data with all or a portion of the new synthetic data.

When the merged data satisfies the desired data quality level, the merged data that satisfies the desired data quality level may be obtained. The merged data that satisfies the desired data quality level may be provided to a user. For example, the merged data that satisfies the desired data quality level may be provided to the user in operation 260 of FIG. 2.

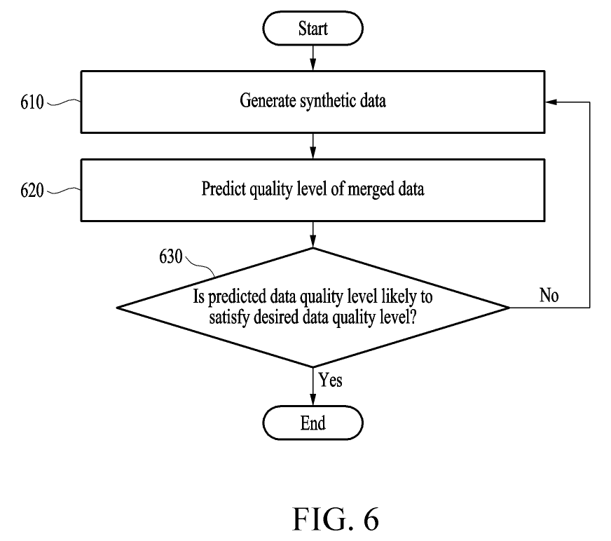

FIG. 6 is a flowchart illustrating an example of an operation of generating synthetic data until it is predicted that merged data satisfies a desired data quality level, according to an embodiment. Referring to FIG. 6, the synthetic data may be repeatedly generated until the predicted data quality level of the merged data is likely to satisfy the desired data quality level.

Synthetic data may be generated in operation 610. Operation 610 may correspond to operation 240 of FIG. 2, operation 320 of FIG. 3, operation 410 of FIG. 4, or operation 510 of FIG. 5. The synthetic data may satisfy a synthetic data quality target or a desired data quality level. After the synthetic data is generated, it may be evaluated whether the generated synthetic data satisfies the synthetic data quality target or the desired data quality level. When the synthetic data does not satisfy the synthetic data quality target or the desired data quality level, new synthetic data may be generated.

In operation 620, the quality level of merged data may be predicted. The predicted quality level of the merged data may refer to a predicted level of data quality of the merged data to be generated by merging original data with the synthetic data. The predicted quality level of the data may be expressed as a range.

It may be evaluated whether the predicted quality level of the data satisfies the desired data quality level. The quality level of the data may not likely satisfy the desired data quality level. For example, when data quality evaluation criteria of the desired data quality level are uniformity and accuracy defined in ISO/IEC 25024, and when a portion of the synthetic data satisfying the accuracy criterion is combined with all of the original data to generate merged data satisfying the uniformity criterion, the merged data may not likely satisfy the accuracy criterion.

In operation 630, when the predicted data quality level is not likely to satisfy the desired data quality level, the process may return to operation 610. When the predicted data is not likely to satisfy the desired data quality level, new synthetic data may be generated. Although FIG. 6 shows that the process returns to operation 610 when the predicted data quality level is not likely to satisfy the desired data quality level, it may also be possible to return to operation 610 when the predicted data quality level is less likely to satisfy the desired data quality level than a certain value.

When the predicted data quality level is likely to satisfy the desired data quality level, the synthetic data may be used to generate the merged data. For example, when the predicted data quality level is likely to satisfy the desired data quality level, the synthetic data may be provided in operation 250 of FIG. 2.

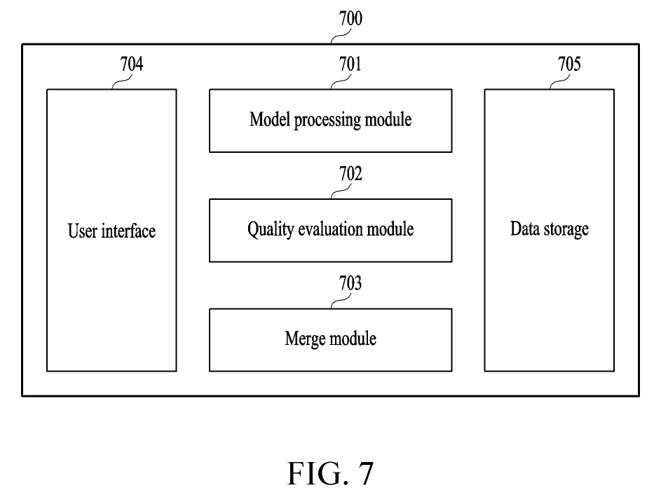

FIG. 7 is a diagram illustrating an example of a configuration of a data generation apparatus including a plurality of hardware modules, according to an embodiment. Referring to FIG. 7, a data generation apparatus 700 may include a model processing module 701, a quality evaluation module 702, a merge module 703, a user interface 704, and data storage 705. The model processing module 701, the quality evaluation module 702, and the merge module 703 of the data generation apparatus 700 may be modules that may perform a portion of the operations of FIGS. 1 to 6.

The model processing module 701 may determine a data generation model suitable for generating synthetic data based on original data received from a user. The model processing module 701 may additionally train the data generation model using all or a portion of the original data. The model processing module 701 may perform preprocessing of the original data before training the data generation model with the original data. The model processing module 701 may execute the data generation model to generate the synthetic data that satisfies a desired data quality level or a synthetic data quality target.

The quality evaluation module 702 may register the desired data quality level received from the user. The quality evaluation module 702 may generate a data quality evaluation function based on the desired data quality level. The quality evaluation module 702 may select a quality evaluation function from one or more stored evaluation functions. The quality evaluation module 702 may evaluate the quality of data based on a data quality evaluation criterion and the quality evaluation function. For example, the quality evaluation module 702 may evaluate the level of data quality of the original data, the synthetic data, and merged data.

The merge module 703 may generate the merged data by combining the original data with the synthetic data. The merge module 703 may generate a merge rule for generating the merged data by combining all or a portion of the original data with all or a portion of the synthetic data based on the desired data quality level. The merge module 703 may generate the merged data based on the merge rule. The merge module 703 may predict the quality level of the merged data before generating the merged data. The merge module 703 may evaluate whether the predicted quality level of the merged data is likely to satisfy the desired data quality level.

The user interface 704 may perform interaction between the user and the data generation apparatus 700. The data generation apparatus 700 may receive the desired data quality level and the original data from the user through the user interface 704. The data generation apparatus 700 may provide the user with the merged data that satisfies the desired data quality level, through the user interface 704. In an embodiment, the data generation apparatus 700 may provide the user with the synthetic data that satisfies the desired data quality level through the user interface 704.

The data storage 705 may store the original data received from the user. The data storage 705 may store the synthetic data and the merged data generated by the data generation apparatus 700. The data storage 705 may perform backups to prevent data loss. In case of data loss, the data storage 705 may perform data recovery procedures using backup data. The data storage 705 may use encryption technology to protect data integrity. The data storage 705 may manage the data using an access control list (ACL), user authentication and authorization, an intrusion detection system (IDS), etc.

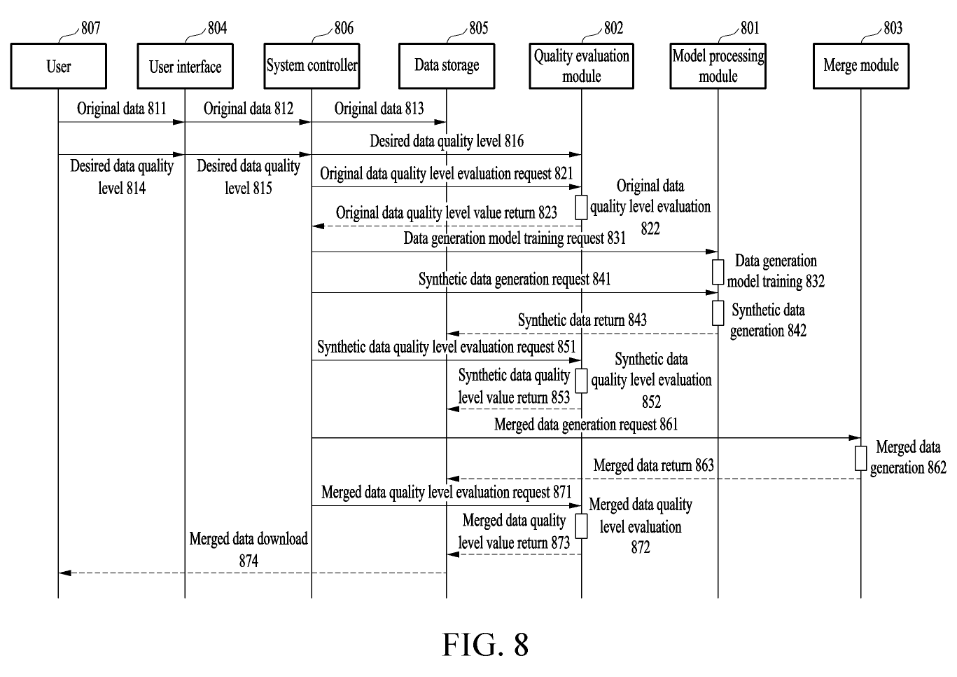

FIG. 8 is a diagram illustrating an example of a data generation process within a data generation apparatus, according to an embodiment. Referring to FIG. 8, the data generation apparatus may receive original data and a desired data quality level from a user 807 through a user interface 804, may generate merged data through processes between a model processing module 801, a quality evaluation module 802, a merge module 803, data storage 805, and a system controller 806, and may provide the merged data to the user 807. The model processing module 801, the quality evaluation module 802, the merge module 803, the user interface 804, and the data storage 805 may respectively correspond to the model processing module 701, the quality evaluation module 702, the merge module 703, the user interface 704, and the data storage 705 of FIG. 7.

The user 807 may upload the original data and the desired data quality level to the user interface 804 in operations 811 and 814. The user interface 804 may upload the original data and the desired data quality levels to the system controller 806 in operations 812 and 815. The system controller 806 may store the original data in the data storage 805 in operation 813. The system controller 806 may register the desired data quality level in the quality evaluation module 802 in operation 816. The quality evaluation module 802 may select a quality evaluation function based on the registered desired data quality level.

The system controller 806 may request the quality evaluation module 802 to evaluate the quality level of the original data in operation 821. The quality evaluation module may evaluate an original data quality level of the original data stored in the data storage 805 using a quality evaluation function in operation 822. The quality evaluation module 802 may return an original data quality level value to the system controller 806 in operation 823.

The system controller 806 may request the model processing module 801 to train a data generation model in operation 831. The model processing module 801 may select an initial model to be trained based on the original data. The model processing module 801 may additionally train the initial model using all or a portion of the original data in operation 832. The system controller 806 may request the model processing module 801 to generate synthetic data in operation 841. The model processing module 801 may generate the synthetic data in operation 842. The synthetic data may be returned to the data storage 805 in operation 843.

The system controller 806 may request the quality evaluation module 802 to evaluate the quality level of the synthetic data in operation 851. The quality evaluation module 802 may evaluate the quality level of the synthetic data in operation 852. The quality evaluation module 802 may return a synthetic data quality level value to the data storage 805 in operation 853. When the synthetic data returned to the data storage 805 does not satisfy a synthetic data quality target or a desired data quality target, the system controller 806 may request the model processing module 801 to generate the synthetic data again in operation 841.

The system controller 806 may request the merge module 803 to generate the merged data in operation 861. The merge module 803 may evaluate whether the merged data that satisfies the desired data quality level is likely to be generated through merging the original data with synthetic data. The merge module 803 may generate a merge rule based on the original data quality level and the desired data quality level. The merge module 803 may generate the merged data in operation 862. The merge module 803 may generate the merged data using the merge rule. The merge module 803 may return the merged data to the data storage 805 in operation 863.

The system controller 806 may request the quality evaluation module 802 to evaluate a merged data quality level in operation 871. The quality evaluation module 802 may evaluate the quality level of the merged data in operation 872. The quality evaluation module 802 may return a merged data quality level value to the data storage 805 in operation 873. When the data quality level value returned to the data storage 805 does not satisfy the desired data quality level, the system controller 806 may re-perform one or more of the previously performed operations. For example, the system controller 806 may request the model processing module 801 to generate the synthetic data again in operation 841. In addition, for example, the system controller 806 may request the merge module 803 to generate the merged data again in operation 861.

When the merged data stored in the data storage 805 satisfies the desired data quality level, the user 807 may download the merged data through the system controller 806 and the user interface 804 in operation 874.

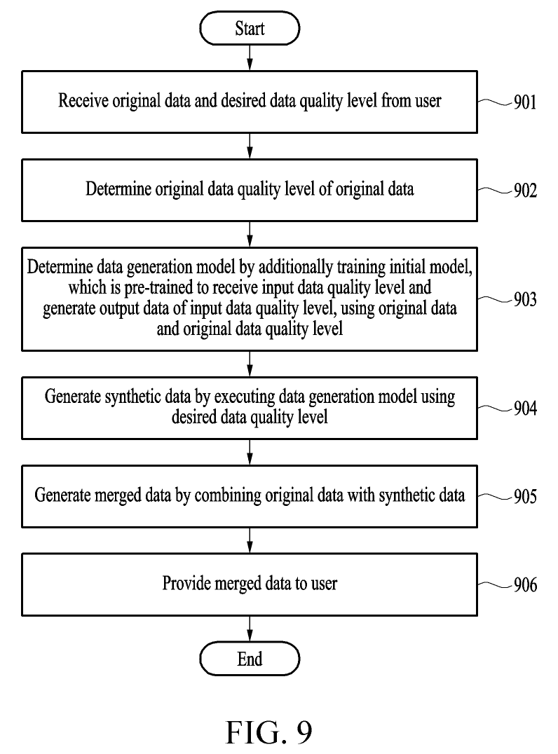

FIG. 9 is a flowchart illustrating a method of providing data that satisfies desired data quality, according to an embodiment. Referring to FIG. 9, in operation 901, a data generation apparatus may receive original data and a desired data quality level from a user. The data generation apparatus may determine a synthetic data quality target based on the desired data quality level and an original data quality level. The desired data quality level may include one or more data evaluation factors selected from among a plurality of predefined evaluation factors and one or more desired threshold levels corresponding to the one or more data evaluation factors. In operation 902, the data generation apparatus may determine the original data quality level of the original data.

In operation 903, the data generation apparatus may determine a data generation model by additionally training an initial model, which is pre-trained to receive an input data quality level and generate output data of the input data quality level, using the original data and the original data quality level. The data generation model may the initial model using data that satisfies the desired data quality level among the original data. The initial model may be selected from among one or more models based on a data type of the original data.

In operation 904, the data generation apparatus may generate synthetic data by executing the data generation model using the desired data quality level. The data generation apparatus may generate the synthetic data by executing the data generation model using the synthetic data quality target. The data generation apparatus may evaluate whether the synthetic data satisfies the synthetic data quality target. When the synthetic data does not satisfy the synthetic data quality target, the data generation apparatus may generate new synthetic data by re-executing the data generation model. When the merged data does not satisfy the desired data quality level, the data generation apparatus may generate new synthetic data by re-executing the data generation model. The data generation apparatus may predict whether the merged data satisfies the desired data quality level. When the merged data is predicted not to satisfy the desired data quality level, the data generation apparatus may generate new synthetic data by re-executing the data generation model.

In operation 905, the data generation apparatus may generate the merged data by combining the original data with the synthetic data. When the synthetic data does not satisfy the synthetic data quality target, the data generation apparatus may generate the merged data by combining the original data with the new synthetic data. The data generation apparatus may evaluate whether the merged data satisfies the desired data quality level. When the merged data does not satisfy the desired data quality level, the data generation apparatus may generate new merged data by recombining the original data with the synthetic data. The data generation apparatus may determine a merge rule for selecting data to be combined with the original data from among the synthetic data, based on the desired data quality level and the original data quality level. The data generation apparatus may generate the merged data based on the merge rule by combining portions of the original data and the synthetic data. When the merged data does not satisfy the desired data quality level, the data generation apparatus may determine a new merge rule for selecting data to be combined with the original data from among the synthetic data. When the merged data does not satisfy the desired data quality level, the data generation apparatus may generate the merged data based on the new merge rule by combining portions of the original data and the synthetic data. When the merged data does not satisfy the desired data quality level, the data generation apparatus may generate the merged data by combining the original data with the new synthetic data. When the merged data is predicted not to satisfy the desired data quality level, the data generation apparatus may generate the merged data by combining the original data with the new synthetic data.

In operation 906, the data generation apparatus may provide the merged data to the user. When the merged data does not satisfy the desired data quality level, the data generation apparatus may provide the new merged data to the user.

In addition, the description provided with reference to FIGS. 1 to 8 may be applied to the data generation method.

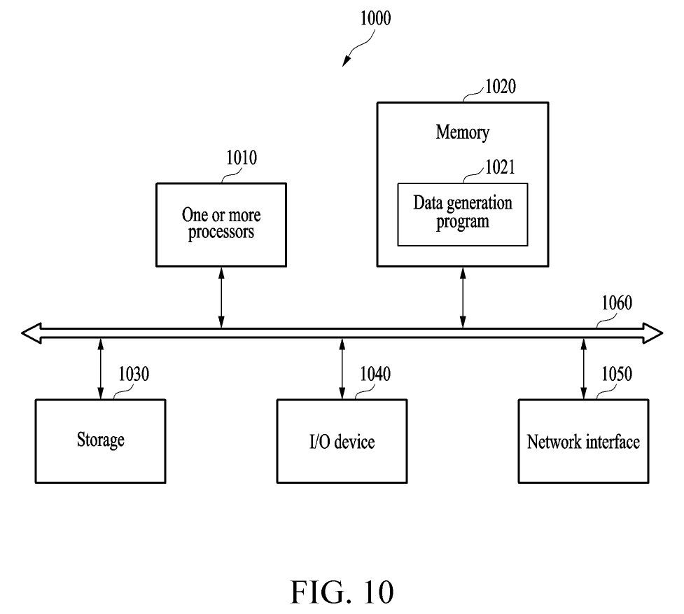

FIG. 10 is a block diagram illustrating a configuration of an electronic device for providing data that satisfies desired data quality, according to an embodiment. Referring to FIG. 7, an electronic device 1000 may include one or more processors 1010, a memory 1020, a storage 1030, an input/output (I/O) device 1040, and a network interface 1050. These components may communicate with each other via a communication bus 1060.

The one or more processors 1010 may execute instructions stored in the memory 1020 or the storage 1030. When executed by the one or more processors 1010, the instructions may cause the electronic device 1000 to perform the operations described with reference to FIGS. 1 to 9. The memory 1020 may include a non-transitory computer-readable storage medium or a non-transitory computer-readable storage device. The memory 1020 may store instructions to be executed by the one or more processors 1010 and may store related information while software and/or an application is being executed by the electronic device 1000. The memory 1020 may store a data generation program 1021 for generating synthetic data of an embodiment. When at least a portion of the data generation program 1021 is stored in the memory 1020, the operations described with reference to FIGS. 1 to 9 may be performed by the electronic device 1000.

The storage 1030 may include a non-transitory computer-readable storage medium or a non-transitory computer-readable storage device. The storage 1030 may store a greater amount of information than the memory 1020 for a longer period of time. For example, the storage 1030 may include a magnetic hard disk, an optical disc, a flash memory, a floppy disk, or other non-volatile memories known in the art.

The I/O device 1040 may receive an input from the user in traditional input manners through a keyboard and a mouse and in new input manners such as a touch input, a voice input, and an image input. For example, the I/O device 1040 may include a keyboard, a mouse, a touch screen, a microphone, or any other device that detects the input from the user and transmits the detected input to the electronic device 1000. The I/O device 1040 may provide an output of the electronic device 1000 to the user through a visual, auditory, or haptic channel. The I/O device 1040 may include, for example, a display, a touch screen, a speaker, a vibration generator, or any other device that provides the output to the user. The network interface 1050 may communicate with an external device through a wired or wireless network.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A data generation method comprising:
receiving original data and a desired data quality level from a user;
determining an original data quality level of the original data;
determining a data generation model by additionally training an initial model, which is pre-trained to receive an input data quality level as input and generate output data of the input data quality level, using the original data and the original data quality level;
generating synthetic data by executing the data generation model using the desired data quality level;
generating merged data by combining the original data with the synthetic data; and
providing the merged data to the user.

2. The data generation method of claim 1, further comprising:
determining a synthetic data quality target based on the desired data quality level and the original data quality level,
wherein the generating of the synthetic data comprises generating the synthetic data by executing the data generation model using the synthetic data quality target.

3. The data generation method of claim 2, wherein
the generating of the synthetic data comprises:
evaluating whether the synthetic data satisfies the synthetic data quality target; and
when the synthetic data does not satisfy the synthetic data quality target, generating new synthetic data by re-executing the data generation model, and
the generating of the merged data comprises, when the synthetic data does not satisfy the synthetic data quality target, generating the merged data by combining the original data with the new synthetic data.

4. The data generation method of claim 1, further comprising:
evaluating whether the merged data satisfies the desired data quality level;
when the merged data does not satisfy the desired data quality level, generating new merged data by recombining the original data with the synthetic data; and
when the merged data does not satisfy the desired data quality level, providing the new merged data to the user.

5. The data generation method of claim 1, wherein
the generating of the merged data comprises:
determining a merge rule for selecting data to be combined with the original data from among the synthetic data, based on the desired data quality level and the original data quality level; and
generating the merged data based on the merge rule by combining the original data and a portion of the synthetic data.

6. The data generation method of claim 5, further comprising:
evaluating whether the merged data satisfies the desired data quality level;
when the merged data does not satisfy the desired data quality level, determining a new merge rule for selecting data to be combined with the original data from among the synthetic data; and
when the merged data does not satisfy the desired data quality level, generating new merged data based on the new merge rule by combining the original data and the portion of the synthetic data.

7. The data generation method of claim 4, further comprising:
when the merged data does not satisfy the desired data quality level, generating new synthetic data by re-executing the data generation model,
wherein the generating of the new merged data comprises, when the merged data does not satisfy the desired data quality level, generating the new merged data by combining the original data with the new synthetic data.

8. The data generation method of claim 1, further comprising:
predicting whether the merged data satisfies the desired data quality level; and
when the merged data is predicted not to satisfy the desired data quality level, generating new synthetic data by re-executing the data generation model,
wherein the generating of the merged data comprises, when the merged data is predicted not to satisfy the desired data quality level, generating the merged data by combining the original data with the new synthetic data.

9. The data generation method of claim 1, wherein
the desired data quality level comprises one or more data evaluation factors selected from among a plurality of predefined evaluation factors and one or more desired threshold levels corresponding to the one or more data evaluation factors.

10. The data generation method of claim 1, wherein
the data generation model is determined by additionally training the initial model using data that satisfies the desired data quality level among the original data.

11. The data generation method of claim 1, wherein
the initial model is selected from among one or more models based on a data type of the original data.

12. A non-transitory computer-readable storage medium storing instructions that, when executed by a processor, cause the processor to perform the method of claim 1.

13. A data generation apparatus comprising:
one or more processors; and
a memory comprising instructions executable by the one or more processors,
wherein the instructions, when executed by the one or more processors, cause the data generation apparatus to:
receive original data and a desired data quality level from a user;
determine an original data quality level of the original data;
determine a data generation model by additionally training an initial model, which is pre-trained to receive an input data quality level as input and generate output data of the input data quality level, using the original data and the original data quality level;
generate synthetic data by executing the data generation model using the desired data quality level;
generate merged data by combining the original data with the synthetic data; and
provide the merged data to the user.

14. The data generation apparatus of claim 13, wherein
the instructions, when executed by the one or more processors, cause the data generation apparatus to:
determine a synthetic data quality target based on the desired data quality level and the original data quality level; and
in order to generate the synthetic data, generate the synthetic data by executing the data generation model using the synthetic data quality target.

15. The data generation apparatus of claim 14, wherein
the instructions, when executed by the one or more processors, cause the data generation apparatus to:
in order to generate the synthetic data, evaluate whether the synthetic data satisfies the synthetic data quality target;
when the synthetic data does not satisfy the synthetic data quality target, generate new synthetic data by re-executing the data generation model; and
in order to generate the merged data, when the synthetic data does not satisfy the synthetic data quality target, generate the merged data by combining the original data with the new synthetic data.

16. The data generation apparatus of claim 13, wherein
the instructions, when executed by the one or more processors, cause the data generation apparatus to:
evaluate whether the merged data satisfies the desired data quality level;
when the merged data does not satisfy the desired data quality level, generate new merged data by recombining the original data with the synthetic data; and
when the merged data does not satisfy the desired data quality level, provide the new merged data to the user.

17. The data generation apparatus of claim 13, wherein
in order to generate the merged data, the instructions, when executed by the one or more processors, cause the data generation apparatus to:
determine a merge rule for selecting data to be combined with the original data from among the synthetic data, based on the desired data quality level and the original data quality level; and
generate the merged data based on the merge rule by combining the original data and a portion of the synthetic data.

18. The data generation apparatus of claim 17, wherein
the instructions, when executed by the one or more processors, cause the data generation apparatus to:
evaluate whether the merged data satisfies the desired data quality level;
when the merged data does not satisfy the desired data quality level, determine a new merge rule for selecting data to be combined with the original data from among the synthetic data; and
when the merged data does not satisfy the desired data quality level, generate new merged data based on the new merge rule by combining the original data and the portion of the synthetic data.

19. The data generation apparatus of claim 13, wherein
the instructions, when executed by the one or more processors, cause the data generation apparatus to:
predict whether the merged data satisfies the desired data quality level;
when the merged data is predicted not to satisfy the desired data quality level, generate new synthetic data by re-executing the data generation model; and
in order to generate the merged data, when the merged data is predicted not to satisfy the desired data quality level, generate the merged data by combining the original data with the new synthetic data.

20. A data generation apparatus comprising:
a user interface configured to receive original data and a desired data quality level from a user and provide the user with merged data based on the original data and the desired data quality level;
a quality evaluation module configured to determine an original data quality level of the original data;
a model processing module configured to determine a data generation model by additionally training an initial model, which is pre-trained to receive an input data quality level as input and generate output data of the input data quality level, using the original data and the original data quality level and generate synthetic data by executing the data generation model using the desired data quality level; and
a merge module configured to generate the merged data by combining the original data with the synthetic data.
